(19) United States
(12) Patent Application Publication
(10) Pub. No.: US 2017/0291653 A1
(43) Pub. Date: Oct. 12, 2017

(54) LEVEL CONTROL IN A MECHANICAL SUSPENSION FOR A WORKING VEHICLE

(71) Applicant: AGCO Corporation, Hesston, KS (US)

(72) Inventors: Derek HRUSKA, Lime Springs, IA (US); Ario KORDESTANI, Jackson, MN (US)

(21) Appl. No.: 15/484,938

(22) Filed: Apr. 11, 2017

Related U.S. Application Data
(60) Provisional application No. 62/320,843, filed on Apr. 11, 2016.

(51) Int. Cl. B62D 55/116; B62D 49/06; B62D 55/108

(52) U.S. Cl. CPC B62D 55/116; B62D 55/108; B62D 49/0628

(57) ABSTRACT

A working vehicle has an undercarriage assembly configured to drive the working vehicle over ground and a chassis connected to the undercarriage assembly through a suspension system. The suspension system includes a mechanical spring, the mechanical spring having a first end connected to the undercarriage assembly and a second end. The suspension system includes a hydraulic cylinder, the hydraulic cylinder having a first portion that mounts to the second end of the mechanical spring and a second portion that connects to the chassis such that the mechanical spring and hydraulic cylinder are arranged in series between the undercarriage assembly and the chassis to modify the height of the chassis. The suspension system is configured to level the chassis to offset the effects of ballast weights or other external loads such as from a drawbar or 3-point hitch.

### CROSS REFERENCE TO RELATED APPLICATION

This application claims the benefit of U.S. Provisional Application No. 62/320,843 filed Apr. 11, 2016, which is hereby incorporated by reference in its entirety.

### BACKGROUND OF THE INVENTION

### Field of Invention

This invention relates generally to suspension systems for a work vehicle, and more particularly to a mechanical suspension that provides level control to the chassis of the work vehicle.

### Description of Related Art

In most off road work vehicles, including agricultural tractors, there are three main suspension types used to separate the main vehicle chassis from the ground engaging undercarriage assembly carrying the vehicle's tracks or wheels. The first is a mechanical suspension, which is typically comprised of a spring element made of either metal coils or an elastomer composite. The second is a pneumatic suspension that typically utilizes air cushions or air bags. The third is a hydraulic suspension. Most hydraulic suspensions use a hydraulic cylinder coupled with an accumulator. These suspension systems are vital to the ride quality of the work vehicle

Mechanical suspensions are adequate in operational ranges they are designed for and often have the advantage of being cost effective and of simpler design. However, mechanical suspensions have typically come with some undesirable limitations. For example, it is often necessary to use ballast weights with these work vehicles. If a vehicle is balanced with no front weight ballast, adding ballast weights to the front end lowers the vehicle's clearance and affects the angle of the vehicle. While both pneumatic and hydraulic suspensions have the ability to actively modify the level or static height of the sprung chassis by adding air or oil to the system, one of the main drawbacks of the mechanical suspension has its inability to modify the level or static height of the chassis.

### OVERVIEW OF THE INVENTION

In one aspect, the invention is directed to a working vehicle having an undercarriage assembly configured to drive the working vehicle over ground and a chassis connected to the undercarriage assembly through a suspension system. The suspension system includes a mechanical spring, the mechanical spring having a first end connected to the undercarriage assembly and a second end. The suspension system includes a hydraulic cylinder, the hydraulic cylinder having a first portion that mounts to the second end of the mechanical spring and a second portion that connects to the chassis such that the mechanical spring and hydraulic cylinder are arranged in series between the undercarriage assembly and the chassis to modify the height of the chassis. The working vehicle has one or more ballast weights mounted to the chassis, and the suspension system is configured to level the chassis to offset the effects of the ballast weights or other external loads such as from the drawbar or 3-point hitch.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a side elevational view of a working vehicle having a suspension system embodying the present invention;

FIG. 2 is a sectional view of one embodiment of the suspension system of FIG. 1;

FIG. 3 is a sectional view of another embodiment of the suspension system of FIG. 1; and

FIG. 4 is an exploded perspective view of the suspension system of FIG. 3.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

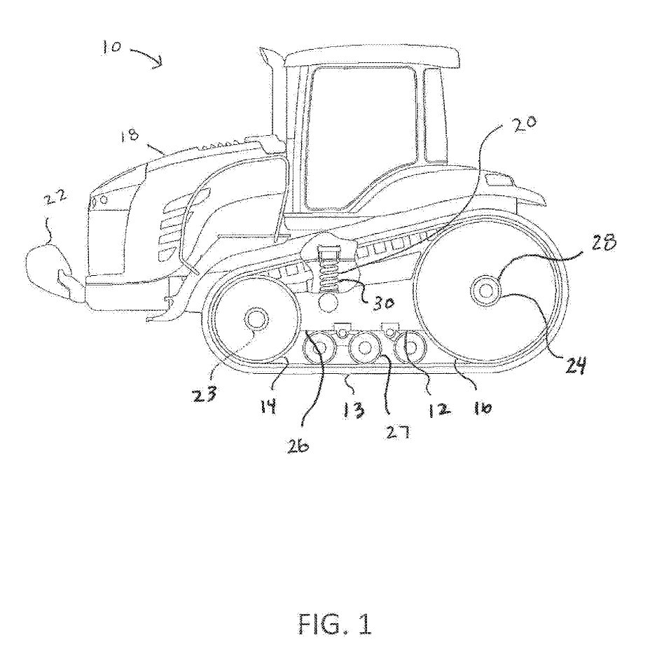

FIG. 1 illustrates a working vehicle 10 having an undercarriage assembly 12 configured to drive the working vehicle over ground. In one embodiment, the working vehicle 10 with the undercarriage assembly 12 is a tracked agricultural tractor, for which it is particularly well suited, however the present invention may be used on a variety of tracked or wheeled work vehicles and should only be limited by the claims that follow. In the illustrated embodiment, the undercarriage assembly 12 includes a ground engaging endless track belt 13 entrained about front wheels 14 and rear wheels 16 and driven by a propulsion system (not shown) of the working vehicle as would be understood by one skilled in the art.

The undercarriage assembly 12 is connected to a chassis 18 of the working vehicle 10 with a suspension system 20 as will be described below. Ballast weights 22 may be attached to the chassis 18. As is understood by those skilled in the art, the use of ballast weights 22 may have an effect on the height and level of the chassis 18. The front wheels 14 are mounted on a front axle 23 and the rear wheels 16 are mounted on a rear axle 24. The undercarriage assembly 12 includes a drive roller frame 26 mounting the front and rear axles 23, 24. Desirably, a plurality of midrollers 27 are mounted on the drive roller frame 26 between the front and rear wheels 14, 16. A rear end of the drive roller frame 26 is configured to rotate about the rear axle 24. Desirably, the drive roller frame 26 is connected to the rear axle 24 with a spherical joint 28 permitting pivoting of the drive roller frame 26 about three axes relative the rear axle 24. The suspension system 20 includes a mechanical spring 30 rigidly connected to the drive roller frame 26 intermediate the front and rear axles 23, 24.

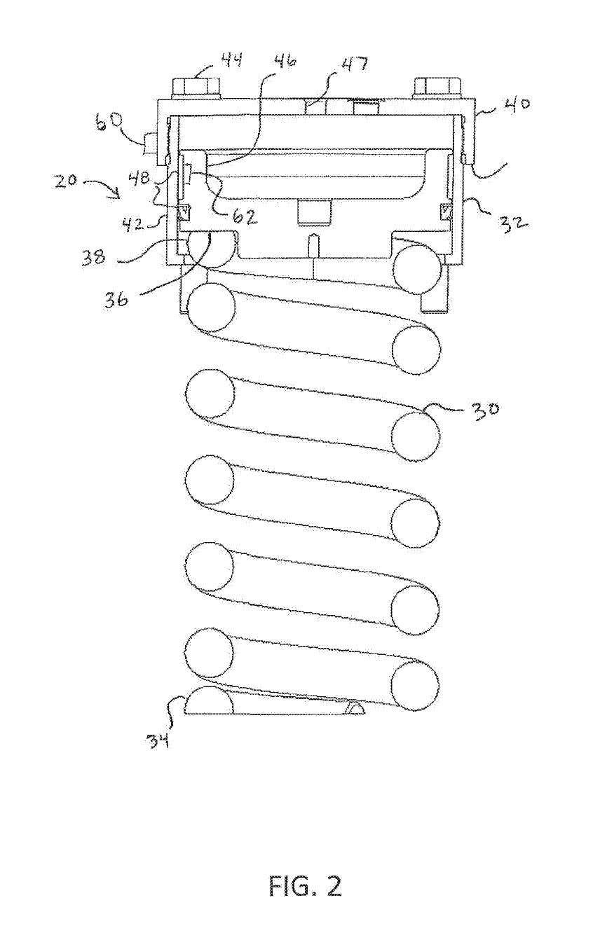

Turning also now to FIG. 2, the suspension system 20 also includes a hydraulic cylinder 32 connected to the mechanical spring 30. In the illustrated embodiment, the mechanical spring 30 is a coil spring, however, other mechanical springs could be used without departing from the scope of the invention. A first, lower end 34 of the mechanical spring 30 is connected to the undercarriage assembly 12 through drive roller frame 26 (FIG. 1). A first portion 36 of the hydraulic cylinder 32 mounts to a second, upper end 38 of the mechanical spring 30. A second portion 39 of the hydraulic cylinder 32 is connected to the chassis 18 (FIG. 1). While the illustrated embodiment has the mechanical spring connected 30 to the undercarriage assembly 12 and the hydraulic cylinder 32 connected to the chassis 18, one skilled in the art will understand that the orientation of the spring 30 and cylinder 32 may be reversed such that the spring 30 is connected to the chassis 18 and the cylinder 32 is connected to the undercarriage assembly 12 without departing from the scope of the invention.

Thus, the suspension system 20 has the mechanical spring 30 and hydraulic cylinder 32 arranged in series between the undercarriage assembly 12 and the chassis 18. In this arrangement, the amount of oil in the hydraulic cylinder 32 can be varied to modify the height of the suspended chassis 18 or be used to level the chassis 18 to offset the effects of adding ballast weights 22 or changes in the height of the chassis 18 caused by other external loads such as from the drawbar or 3-point hitch. Desirably, the hydraulic cylinder 32 utilizes a short stroke design to conform to available space requirements of the chassis 18.

In the embodiment illustrated in FIG. 2, the hydraulic cylinder 32 has a cylinder head 40 mounted on a cylinder body 42 with suitable bolts 44. A ram 46 moves in the cylinder body 42 based on the amount of hydraulic fluid supplied to the cylinder 32 through port 47. The first portion 36 of the hydraulic cylinder 32 is comprised of a lower portion of the ram 46, thereby attaching the ram 46 to the mechanical spring 30. The cylinder head 40 is affixed to the chassis 18. The hydraulic cylinder 32 has suitable rings and seals 48 positioned between the ram 46 and the cylinder body 42. Thus, to change the level or the height of the chassis 18 with respect to the undercarriage assembly 12, hydraulic fluid is supplied or withdrawn from the hydraulic cylinder 32 to change the position of the ram 46 with respect to the cylinder head 40.

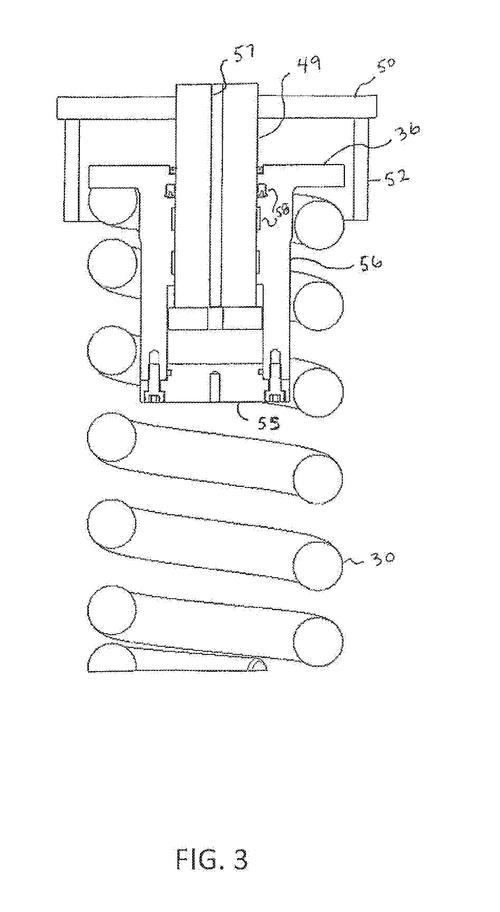

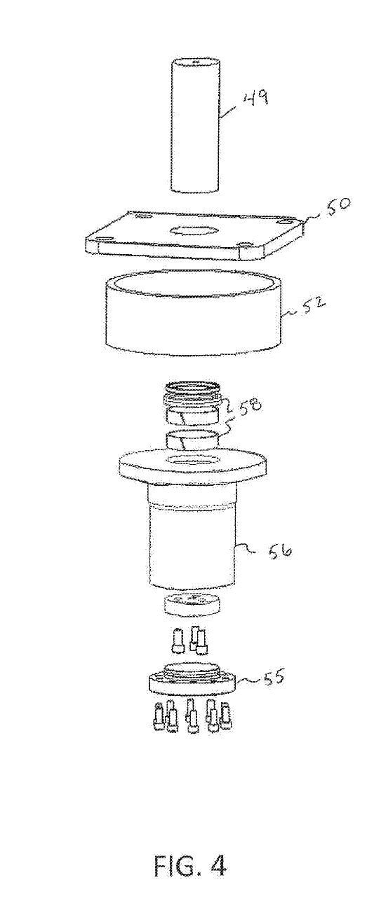

FIGS. 3 and 4 illustrate another embodiment of a suitable hydraulic cylinder 32 used with the mechanical spring 30 in the suspension system 20. In this embodiment, the hydraulic cylinder 32 has a piston rod 49 that connects to the chassis 18 through a piston head 50 on its top side. The piston rod 49 passes through a rod guide 56 and interfaces with a containing plate 63 preventing the system from expanding beyond its designed limits. A cap 55 is attached to lower end of the piston guide 56. The hydraulic cylinder 32 has suitable rings and seals 58 positioned between the piston rod 49 and the piston guide 56. The piston guide 56 moves with respect to the piston rod 49 and connecting frame members 50 and 52 based on the amount of hydraulic fluid supplied to the cylinder 32 through port 57. The first portion 36 of the hydraulic cylinder 32 is comprised of a portion of the rod guide 56, thereby attaching the rod guide 56 to the mechanical spring 30. The cylinder head 50 is affixed to the chassis 18. Thus, to change the level or the height of the chassis 18 with respect to the undercarriage assembly 12, hydraulic fluid is supplied or withdrawn from the hydraulic cylinder 32 to change the position of the rod guide 56 with respect to the cylinder head 50. One skilled in the art will understand that other hydraulic cylinders 32 may be used using sound engineering judgment.

Desirably, the suspension system 20 includes a sensor 64 configured to measure the difference between the sprung and unsprung chassis 18. Referring back to FIG. 2, in one embodiment, the sensor comprises a Hall Effect sensor 64 mounted on the cylinder head 40 and a magnet 65 imbedded in the ram 46 to give the distance between the cylinder head 40 and the ram 46. Knowing the location of the ram 46, the pressure in the hydraulic cylinder 32 and the spring rate of the mechanical spring 30, one can determine the required stroke of the ram 46 to achieve a desired level of the chassis 18. However, one skilled in the art will understand that the distance between the sprung and unsprung chassis 18 may be measured using other known position measuring means, such as angle sensors and linear encoders without departing from the scope of the invention.

It is believed that the suspension system 20 described herein has the advantage of providing a system that can provide a leveling feature to the work vehicle 10 that is of low material cost, simple design, and basic control logic. Additionally, the described suspension system 20 may allow for additional features to be utilized by the work vehicle 10 such as the ability to more easily remove ballast weights 22 by lowering the front end of the working vehicle 10 as well as changing the entry method. With this invention, a significant height change can be obtained through the travel differences of the suspension system 20. With that in mind, the initial step that is fixed on the sprung chassis 18 can be raised because the work vehicle 10 can now lower the front of the machine 10 effectively reducing the height of the first step when it is powered on/off but gives the required clearance when the vehicle 10 is in use.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A working vehicle comprising:
a vehicle chassis;
an undercarriage assembly connected to the vehicle chassis configured to drive the working vehicle over ground, the undercarriage assembly includes a drive roller frame mounting a front axle and a rear axle, wherein the drive roller frame is configured to rotate about the rear axle;
a suspension system connecting the chassis to the undercarriage assembly, the suspension system comprising:
a mechanical spring having a first end connected to one of the drive roller frame of the undercarriage assembly and the chassis, and a second end; and
a hydraulic cylinder, the hydraulic cylinder having a first portion that mounts to the second end of the mechanical spring and a second portion that connects to the other of the chassis and the drive roller frame of the undercarriage assembly, such that the mechanical spring and hydraulic cylinder are arranged in series between the undercarriage assembly and the chassis, wherein the mechanical spring and hydraulic cylinder are attached to the drive roller frame intermediate the front axle and rear axle.

2. The working vehicle of claim 1 wherein the working vehicle is an agricultural tractor and the undercarriage assembly comprises at least one endless track belt.

3. The working vehicle of claim 1 wherein the mechanical spring is a coil spring.

4. The working vehicle of claim 1 further comprising one or more ballast weights mounted to the chassis, wherein the suspension system is configured to level the chassis to offset the effects of the ballast weights.
